(19) United States
(12) Patent Application Publication
(10) Pub. No.: US 2026/0353371 A1
(43) Pub. Date: Nov. 5, 2026

(54) ACCESS POINT AND TERMINAL

(71) Applicant: NTT, Inc., Tokyo (JP)

(72) Inventors: Akira KISHIDA, Musashino-shi (JP); Kengo NAGATA, Musashino-shi (JP); Yusuke ASAI, Musashino-shi (JP); Yasushi TAKATORI, Musashino-shi (JP)

(73) Assignee: NTT, Inc., Tokyo (JP)

(21) Appl. No.: 19/474,192

(22) PCT Filed: Apr. 14, 2023
(86) PCT No.: PCT/JP2023/015145

§ 371 Date: Oct. 10, 2025

(51) Int. Cl. H04W 72/0446; H04W 72/0457; H04W 74/0816

(52) U.S. Cl. CPC H04W 72/0446; H04W 72/0457; H04W 74/0816

(57) ABSTRACT

An access point of an embodiment includes a plurality of wireless signal processing units and a management unit. The management unit establishes a plurality of links by using the plurality of wireless signal processing units, and allocates a service period that gives priority to transmission and reception of low-latency traffic to each of the plurality of links in an allocation pattern in which no break of the service period occurs in switching of the service period among the plurality of links.

### TECHNICAL FIELD

An embodiment of the present invention relates to an access point and a terminal.

### BACKGROUND ART

A wireless local area network (LAN) is known as a communication system that wirelessly connects an access point (hereinafter “AP”) and a terminal. The AP and the terminal as wireless stations of the wireless LAN perform carrier sensing based on carrier sense multiple access with collision avoidance (CSMA/CA), and transmit data when a transmission right is obtained. In IEEE 802.11be under development as a successor standard of IEEE 802.11ax, it is possible to establish a link set including a plurality of links between the terminal and the AP. In a case where the link set including the plurality of links is established, the wireless station performs carrier sensing based on CSMA/CA for each link, and transmits a data frame using the link for which the transmission right has been obtained.

In addition, as the communication system as described above, there is a communication system in which transmission and reception of low-latency traffic requiring low latency is performed between the terminal and the AP using a restricted target wake time (R-TWT) function. In such a communication system, the AP sets a service period (also referred to as “R-TWT service period (SP)”) that gives priority to transmission and reception of the low-latency traffic, and provides notification of information regarding the set service period using a beacon. Then, the terminal that performs transmission processing for the low-latency traffic receives the beacon from the AP, thereby acquiring the information regarding the service period. Then, the terminal deterministically transmits the allocated low-latency traffic to the AP in a preset service period on the basis of the information regarding the service period. At this time, the AP reduces delay and jitter in the transmission and reception of the low-latency data by setting the service period with a cycle corresponding to a delay request of the low-latency traffic.

The low-latency traffic for which low latency is required is not only periodically generated, but also non-periodically generated. The communication between the terminal and the AP of the communication system requires to satisfy the delay request even for the non-periodically generated low-latency traffic. In addition, in a case where the link set including a plurality of links is established between the terminal and the AP, it is required to suppress a decrease in frequency utilization efficiency by suppressing a decrease in utilization efficiency of the plurality of links or the like.

### CITATION LIST

### Non Patent Literature

Non Patent Literature 1: IEEE802.11be D3.0, “35.8 Restricted TWT (R-TWT)”, p 617-p 621, January 2023

### SUMMARY OF INVENTION

### Technical Problem

An object of the present invention is to provide an access point and a terminal that satisfy a delay request of non-periodically generated low-latency traffic and suppress a decrease in frequency utilization efficiency.

### Solution to Problem

In an embodiment of the present invention, an access point includes a plurality of wireless signal processing units and a management unit. The management unit establishes a plurality of links by using the plurality of wireless signal processing units, and allocates a service period that gives priority to transmission and reception of low-latency traffic to each of the plurality of links in an allocation pattern in which no break of the service period occurs in switching of the service period among the plurality of links.

### Advantageous Effects of Invention

According to the present invention, there are provided an access point and a terminal that satisfy a delay request of non-periodically generated low-latency traffic and suppress a decrease in frequency utilization efficiency.

### BRIEF DESCRIPTION OF DRAWINGS

FIG. 1 is a block diagram illustrating an example of a configuration of a communication system according to a first embodiment.

FIG. 2 is a schematic diagram illustrating an example of link management information between an AP and a terminal in the communication system according to the first embodiment.

FIG. 3 is a block diagram illustrating an example of a hardware configuration of the AP according to the first embodiment.

FIG. 4 is a block diagram illustrating an example of a hardware configuration of a terminal according to the first embodiment.

FIG. 5 is a block diagram illustrating an example of a functional configuration of the AP according to the first embodiment.

FIG. 6 is a block diagram illustrating an example of a functional configuration of the terminal according to the first embodiment.

FIG. 7 is a schematic diagram illustrating an example of an allocation pattern for an R-TWT SP determined by a management unit of the AP in the first embodiment.

FIG. 8 is a block diagram illustrating an example of a functional configuration of one of wireless signal processing units of the AP in the first embodiment.

FIG. 9 is a schematic diagram illustrating an example of a format of a beacon frame generated by a beacon control unit and a frame processing unit in the AP according to the first embodiment.

FIG. 10 is a block diagram illustrating an example of a functional configuration of a transmission/reception unit of the wireless signal processing unit in the AP according to the first embodiment.

FIG. 11 is a block diagram illustrating an example of a functional configuration of one of wireless signal processing units of the terminal in the first embodiment.

FIG. 12 is a flowchart schematically illustrating an example of processing performed by the AP and the terminal in the first embodiment.

FIG. 13 is a flowchart schematically illustrating an example of processing performed in one SP by the terminal according to the first embodiment.

FIG. 14 is a schematic diagram illustrating an example of temporal changes in a communication state through a link set between the AP and the terminal in the communication system according to the first embodiment.

FIG. 15 is a block diagram illustrating an example of a functional configuration of a terminal according to one modification.

### DESCRIPTION OF EMBODIMENTS

Hereinafter, an embodiment of the present invention will be described with reference to the drawings.

### First Embodiment

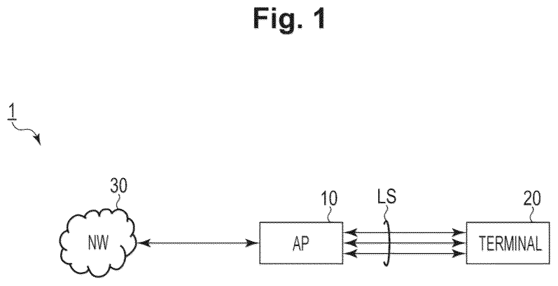

First, a first embodiment will be described as an example of embodiments. FIG. 1 is a block diagram illustrating an example of a configuration of a communication system 1 according to the first embodiment. As illustrated in FIG. 1, the communication system 1 includes an access point (that will be hereinafter referred to as an “AP”) 10, a terminal 20, and a network 30. The AP 10 is also referred to as a “base station” of a wireless LAN. The AP 10 communicates with a server (not illustrated) on the network 30 in a wired or wireless manner. The terminal 20 is, for example, any of a smartphone, a mobile phone, a tablet personal computer (PC), a desktop PC, a laptop PC, or an Internet of things (IoT) sensor/device.

The AP 10 can be wirelessly connected with the terminal 20, and wirelessly communicates with the terminal 20. The wireless communication between the terminal 20 and the AP 10 conforms to the IEEE 802.11 standard. Note that, although wireless communication conforming to the IEEE 802.11 standard will be described as an example in the following description, a wireless communication standard different from the IEEE 802.11 standard may be used. Each of the AP 10 and the terminal 20 has a wireless communication function based on an open systems interconnection (OSI) reference model defined in the IEEE 802.11 standard. In the OSI reference model, the wireless communication function is divided into seven layers (a first layer: a physical layer, a second layer: a data link layer, a third layer: a network layer, a fourth layer: a transport layer, a fifth layer: a session layer, a sixth layer: a presentation layer, and a seventh layer: an application layer). The data link layer serving as the second layer includes a logical link control (LLC) sublayer and a media access control (MAC) sublayer.

In the wireless connection between the AP 10 and the terminal 20, a link set LS including a plurality of links is established. Each of the plurality of links of the link set LS is established by using an affiliated AP (hereinafter referred to as “A-AP”) function provided as a functional configuration in the AP 10 and an affiliated STA (hereinafter referred to as “A-STA (affiliated station)”) function provided as a functional configuration in the terminal 20. In the present embodiment, the AP 10 is provided with a plurality of the A-AP functions, and the terminal 20 is provided with a plurality of the A-STA functions. Each of the A-AP function of the AP 10 and the A-STA function of the terminal 20 corresponds to a wireless signal processing unit to be described below.

In the present embodiment, a multi-link can be applied to a wireless connection method between the AP 10 and the terminal 20. In the multi-link, it is possible to transmit and receive data (exchange traffic) by simultaneously using a plurality of links constituting the link set LS. That is, in the multi-link, each of the AP 10 and the terminal 20 can transmit and receive data by the plurality of links constituting the link set LS in parallel to one another. The AP 10 and the terminal 20 manage a state of the link between the AP 10 and the terminal 20 including a state of the link set LS by link management information.

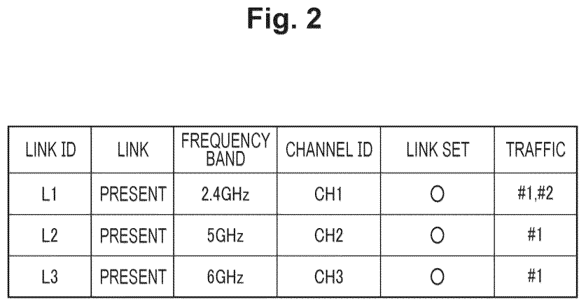

FIG. 2 is a schematic diagram illustrating an example of the link management information between the AP 10 and the terminal 20 in the communication system 1 according to the present embodiment. The link management information indicates, for example, information of each of a “link ID”, a “link”, a “frequency band”, a “channel ID”, a “link set”, and “traffic”. The “link ID” is an identifier of a link. In a case where the multi-link is applied to the wireless connection method between the AP 10 and the terminal 20, one link can be established between one A-AP function and one A-STA function. In the example of FIG. 2, in the AP 10, three A-AP functions (A-AP 1, A-AP 2, and A-AP 3) are allocated to the wireless communication with the terminal 20, and in the terminal 20, three A-STA functions (A-STA 1, A-STA 2, and A-STA 3) are allocated to the wireless communication with the AP 10. Then, a link L1 can be established between the A-AP 1 and the A-STA 1, a link L2 can be established between the A-AP 2 and the A-STA 2, and a link L3 can be established between the A-AP 3 and the A-STA 3.

Information of the “link” indicates whether each of the plurality of A-AP functions of the AP 10 has established the above-described link with the terminal 20. The example in FIG. 2 illustrates a state in which each of the A-AP 1 to the A-AP 3 of the AP 10 has established the link with the terminal 20, and a state in which each of the links L1 to L3 has been established. Information of the “frequency band” indicates a frequency band allocated to each link. As the frequency band, for example, a 6 GHz band, a S GHz band, and a 2.4 GHz band can be applied. The plurality of frequency bands includes a plurality of channels, respectively. The “channel ID” indicates an ID of a channel allocated to each of the links. In the example in FIG. 2, a channel CH1 having the 2.4 GHz band, a channel CH2 having the 5 GHz band, and a channel CH3 having the 6 GHz band are respectively allocated to the link L1, the link L2, and the link L3. Note that, in the plurality of links of the link set LS, frequency bands different from one another may be allocated, or different channels of the same frequency band as one another may be allocated.

Information of the “link set” indicates whether the link set LS including a plurality of links has been established between the AP 10 and the terminal 20. Moreover, in a case where the link set LS has been established, the information of the “link set” indicates which link constitutes the link set LS. In the example in FIG. 2, the three links L1 to L3 constitute the link set LS. Further, in the present embodiment, the information regarding the “link set” in the example of FIG. 2 indicates that the multi-link by the three links L1 to L3 constituting the link set LS is applied to the wireless connection method between the AP 10 and the terminal 20.

Here, in the state in which the multi-link by the link set LS is established between the AP 10 and the terminal 20, each of the plurality of A-AP functions (first wireless signal processing units) of the AP 10 can perform wireless communication through a corresponding one of the plurality of links of the link set LS. For example, the A-AP 1, the A-AP 2, and the A-AP 3 can wirelessly communicate through the links L1, L2, and L3, respectively. Further, in the state in which the multi-link by the link set LS is established between the AP 10 and the terminal 20, each of the plurality of A-STA functions (second wireless signal processing units) of the terminal 20 can perform wireless communication through a corresponding one of the plurality of links of the link set LS. For example, the A-STA 1, the A-STA 2, and the A-STA 3 can wirelessly communicate through the links L1, L2, and L3, respectively.

Information of the “traffic” indicates a traffic identifier (TID) of traffic allocated to each link. The TID is an identifier indicating each piece of traffic, and each piece of traffic may be associated with an access category. The access category of the traffic includes, for example, “voice (VO)”, “video (VI)”, “best effort (BE)”, “background (BK)”, and “real time (RT)”. In the example in FIG. 2, TIDs #1 and #2 correspond to any of VO, VI, BE, BK, or RT. Then, the traffic of the TID #1 is allocated to each of the links L1 to L3. That is, each of the links L1 to L3 is allocated to transmission and reception of the TID #1. Further, the traffic of the TID #2 is allocated only to the link L1. That is, only the link L1 is allocated to transmission and reception of the TID #2.

Here, in the state in which the multi-link by the link set LS is established between the AP 10 and the terminal 20, only one link of the link set LS may be allocated to transmission and reception of one TID, or a plurality of links of the link set LS may be allocated. Further, the association between the traffic and the link (the A-AP function of the AP 10 and the A-STA function of the terminal 20) is set such that a traffic amount (data amount) is equal among the plurality of links constituting the link set LS. Note that the association between the traffic and the link is not limited to the above-described example. In one example, traffic of similar types relative to each other may be aggregated on a particular link of the link set LS. For example, in a case where low-latency traffic for which low latency is required is periodically generated, a specific link of the link set LS may be allocated to transmission and reception of the low-latency traffic that is periodically generated.

Further, the AP 10 and the terminal 20 have a restricted target wake time (R-TWT) function. By using the R-TWT function, the AP 10 and the terminal 20 secure an opportunity to perform the above-described transmission and reception of low-latency traffic between the AP 10 and the terminal 20 using the established link set LS. A service period in which the transmission and reception of the low-latency traffic can be prioritized over transmission and reception of another traffic for which low latency is not required is set by the R-TWT function. The above-described service period set by the R-TWT function is also referred to as an “R-TWT service period (R-TWT SP)”. Note that, in the following description, the service period set by the R-TWT function is also simply referred to as “SP”.

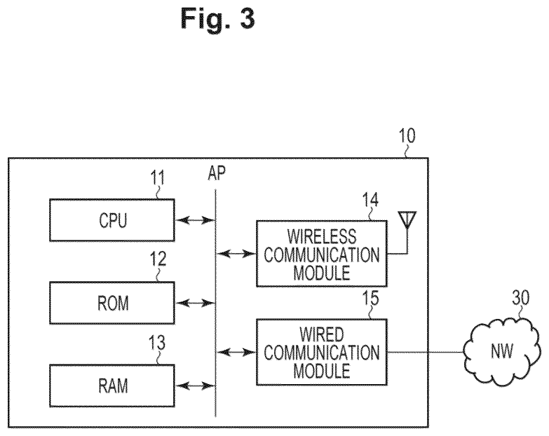

FIG. 3 is a block diagram illustrating an example of a hardware configuration of the AP 10 according to the present embodiment. As illustrated in FIG. 3, the AP 10 includes, for example, a central processing unit (CPU) 11, a read only memory (ROM) 12, a random access memory (RAM) 13, a wireless communication module 14, and a wired communication module 15. The CPU 11 is a processing circuit that controls the entire operation of the AP 10. The ROM 12 is, for example, a nonvolatile semiconductor memory. The ROM 12 stores a program for controlling the AP 10, and data. The RAM 13 is, for example, a volatile semiconductor memory. The RAM 13 is used as a working area of the CPU 11. The wireless communication module 14 is a circuit used to transmit and receive data with a wireless signal. The wireless communication module 14 is connected to an antenna. The wired communication module 15 is a circuit used to transmit and receive data with a wired signal. The wired communication module 15 is connected to the network 30.

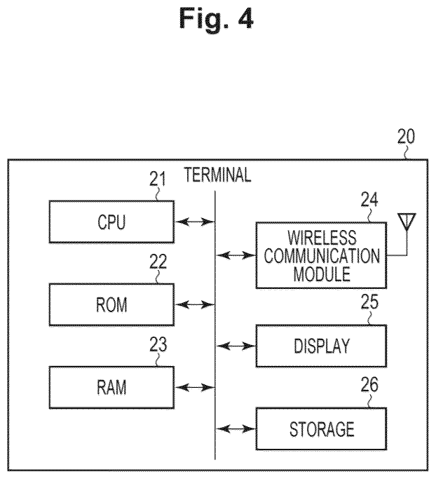

FIG. 4 is a block diagram illustrating an example of a hardware configuration of the terminal 20 according to the present embodiment. As illustrated in FIG. 4, the terminal 20 includes, for example, a CPU 21, a ROM 22, a RAM 23, a wireless communication module 24, a display 25, and a storage 26. The CPU 21 is a processing circuit that controls the entire operation of the terminal 20. The ROM 22 is, for example, a nonvolatile semiconductor memory. The ROM 22 stores a program for controlling the terminal 20, and data. The RAM 23 is, for example, a volatile semiconductor memory. The RAM 23 is used as a working area of the CPU 21. The wireless communication module 24 is a circuit used to transmit and receive data with a wireless signal. The wireless communication module 24 is connected with an antenna. The display 25 is, for example, a liquid crystal display (LCD) or an electro-luminescence (EL) display. The display 25 displays a graphical user interface (GUI) corresponding to application software, or the like. The storage 26 is a nonvolatile storage device. The storage 26 stores system software of the terminal 20, and the like.

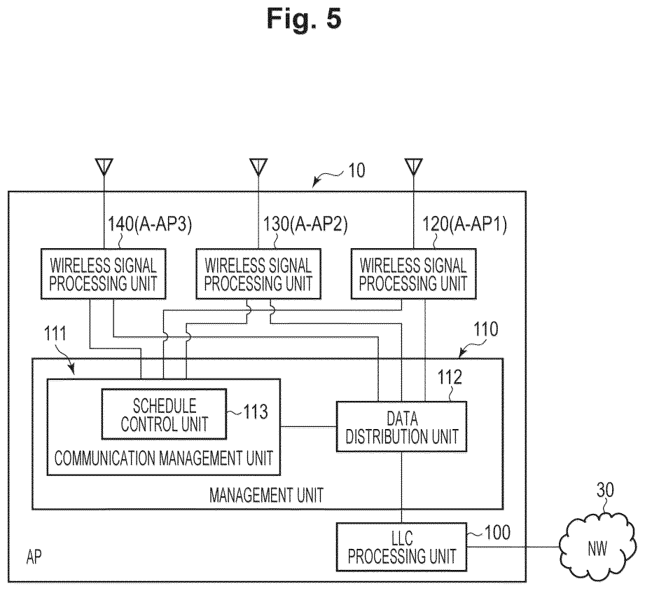

FIG. 5 is a block diagram illustrating an example of a functional configuration of the AP 10 according to the present embodiment. As illustrated in FIG. 5, the AP 10 includes, for example, an LLC processing unit 100, a management unit 110, and wireless signal processing units 120, 130, and 140. Processing of the LLC processing unit 100 can be implemented by, for example, a combination of the CPU 11, the RAM 13, and the wired communication module 15. Processing of the management unit 110 and each of the wireless signal processing units 120, 130, and 140 can be implemented by, for example, a combination of the CPU 11, the RAM 13, and the wireless communication module 14. The LLC processing unit 100 executes, for example, processing of the LLC sublayer of the second layer and processing of the third layer to the seventh layer. The management unit 110 executes processing of the MAC sublayer of the second layer. The wireless signal processing units 120, 130, and 140 execute processing of the MAC sublayer of the second layer and processing of the first layer. The management unit 110 includes a communication management unit 111 and a data distribution unit 112, and the communication management unit 111 includes a schedule control unit 113.

The LLC processing unit 100 adds a destination service access point (DSAP) header, a source service access point (SSAP) header, and the like to data received from the network 30 to generate an LLC packet. Then, the LLC processing unit 100 inputs the generated LLC packet as data to the data distribution unit 112 of the management unit 110. Further, the LLC processing unit 100 receives the LLC packet as data from the data distribution unit 112 of the management unit 110, and extracts a portion other than the DSAP header, the SSAP header, and the like as data from the received LLC packet. Then, the LLC processing unit 100 transmits the extracted data to the network 30.

The management unit (first management unit) 110 is also referred to as “multi-link device (MLD)”. In the management unit 110, the communication management unit 111 manages a communication state between the AP 10 and the terminal 20 including the state of the link between the AP 10 and the terminal 20. The communication management unit 111 manages the communication state between the AP 10 and the terminal 20 on the basis of management information regarding the wireless communication and the like. The management information regarding the wireless communication includes management information regarding the link between the AP 10 and the terminal 20 such as the link management information in the example of FIG. 2, management information regarding the R-TWT at the time of use of the R-TWT function, and the like.

Further, the communication management unit 111 can exchange notification information regarding wireless communication with each of the wireless signal processing units 120, 130, and 140. The notification information regarding wireless communication includes notification information regarding the link between the AP 10 and the terminal 20, notification information regarding the R-TWT at the time of use of the R-TWT function, and the like. The communication management unit 111 updates the management information regarding the wireless communication on the basis of the notification information from each of the wireless signal processing units 120, 130, and 140.

Further, in the management unit 110, the data distribution unit 112 distributes the data such as the LLC packet received from the LLC processing unit 100 to the wireless signal processing units 120, 130, and 140, and inputs the data from the LLC processing unit 100 to the corresponding wireless signal processing unit (one or more corresponding wireless signal processing units of 120, 130, and 140). In one example, in a case of receiving the traffic for which low latency is not required, the data distribution unit 112 specifies the link associated with the TTD of the received traffic from the link set LS. Then, the data distribution unit 112 inputs the data (traffic) to the wireless signal processing unit (one or more corresponding wireless signal processing units 120, 130, and 140) corresponding to the specified link. Further, when receiving data from any of the wireless signal processing units 120, 130, and 140, the data distribution unit 112 inputs the received data such as the LLC packet to the LLC processing unit 100.

The wireless signal processing units (first wireless signal processing units) 120, 130, and 140 respectively correspond to the above-described A-AP 1, A-AP 2, and A-AP 3 that are the A-AP functions of the AP 10. The wireless signal processing units 120, 130, and 140 have functional configurations similar to each other. Each of the wireless signal processing units 120, 130, and 140 can transmit the notification information input from the communication management unit 111 as a wireless signal. Further, each of the wireless signal processing units 120, 130, and 140 transmits the data such as the LLC packet received from the data distribution unit 112 as a wireless signal. In the example of FIG. 5, one antenna is provided corresponding to each of the wireless signal processing units 120, 130, and 140, but the wireless signal processing units 120, 130, and 140 may use a common antenna.

In a case of receiving the LLC packet as data from the data distribution unit 112, each of the wireless signal processing units 120, 130, and 140 adds a MAC header to the received LLC packet to generate a MAC frame. Further, in a case of transmitting the notification information input from the communication management unit 111, each of the wireless signal processing units 120, 130, and 140 generates the MAC frame including the input notification information. Note that, in the following description, a MAC frame including data is also referred to as a “data frame”, and a frame including the notification information is also referred to as a“notification frame”. Each of the wireless signal processing units 120, 130, and 140 adds a preamble, a physical layer (PHY) header, and the like to the generated MAC frame to generate a wireless frame. Then, each of the wireless signal processing units 120, 130, and 140 performs a predetermined modulation operation for the generated wireless frame to convert the wireless frame into a wireless signal, and radiates (transmits) the wireless signal via an antenna. The predetermined modulation operation includes, for example, convolutional coding, interleaving, subcarrier modulation, inverse fast Fourier transform (IFFT), orthogonal frequency division multiplexing (OFDM) modulation, frequency conversion, and the like.

Moreover, each of the wireless signal processing units 120, 130, and 140 performs a predetermined demodulation operation to convert the wireless signal from the terminal 20 or the like received via the antenna into the wireless frame. The predetermined demodulation operation includes, for example, frequency conversion, OFDM demodulation, fast Fourier transform (FFT), subcarrier demodulation, deinterleaving, and Viterbi decoding. Then, each of the wireless signal processing units 120, 130, and 140 extracts the MAC frame from the wireless frame. In a case where the extracted MAC frame is a data frame, each of the wireless signal processing units 120, 130, and 140 extracts the data such as the LLC packet from the MAC frame, and inputs the extracted data to the data distribution unit 112. In a case where the extracted MAC frame is a notification frame, each of the wireless signal processing units 120, 130, and 140 extracts the notification information from the MAC frame, and inputs the extracted notification information to the communication management unit 111.

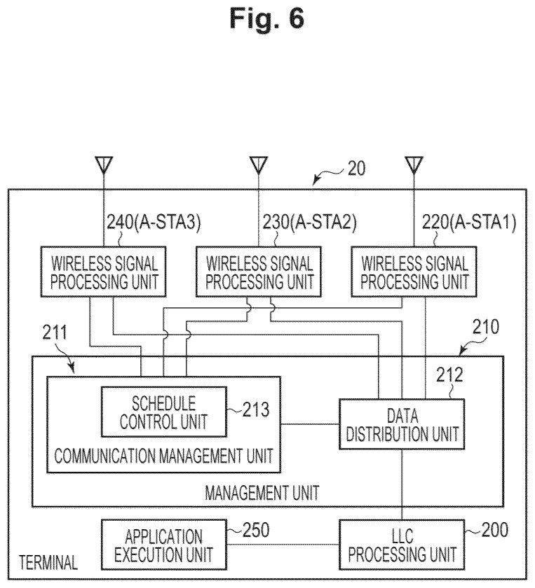

FIG. 6 is a block diagram illustrating an example of a functional configuration of the terminal 20 according to the present embodiment. As illustrated in FIG. 6, the terminal 20 includes, for example, an application execution unit 250, an LLC processing unit 200, a management unit 210, and wireless signal processing units 220, 230, and 240. Processing of each of the application execution unit 250 and the LLC processing unit 200 can be implemented by, for example, the CPU 21 and the RAM 23. Processing of the management unit 210 and each of the wireless signal processing units 220, 230, and 240 can be implemented by, for example, a combination of the CPU 21, the RAM 23, and the wireless communication module 24. The application execution unit 250 executes processing of the seventh layer, and the LLC processing unit 200 executes processing of the LLC sublayer of the second layer and processing of the third layer to the sixth layer. The management unit 210 executes processing of the MAC sublayer of the second layer, and each of the wireless signal processing units 220, 230, and 240 executes processing of the MAC sublayer of the second layer and processing of the first layer. The management unit 210 includes a communication management unit 211 and a data distribution unit 212, and the communication management unit 211 includes a schedule control unit 213.

The application execution unit 250 executes an application on the basis of data inputted from the LLC processing unit 200. Moreover, the application execution unit 250 inputs data to the LLC processing unit 200 in accordance with the operation of the application. The application execution unit 250 can display application information on the display 25. Moreover, the application execution unit 250 can execute processing corresponding to an operation at the input interface.

The LLC processing unit 200 adds a DSAP header, an SSAP header, and the like to data received from the application execution unit 250 to generate an LLC packet. Then, the LLC processing unit 200 inputs the generated LLC packet as data to the data distribution unit 212 of the management unit 210. Further, the LLC processing unit 200 receives the LLC packet as data from the data distribution unit 212 of the management unit 210, and extracts a portion other than the DSAP header, the SSAP header, and the like as data from the received LLC packet. Then, the LLC processing unit 200 inputs the extracted data to the application execution unit 250.

The management unit (second management unit) 210 is also referred to as “MLD”. In the management unit 210, the communication management unit 211 cooperates with the communication management unit 111 of the AP 10 to manage the communication state between the AP 10 and the terminal 20 including the state of the link between the AP 10 and the terminal 20. The communication management unit 211 manages the communication state between the AP 10 and the terminal 20 on the basis of the above-described management information regarding the wireless communication and the like. Further, the communication management unit 211 can exchange the above-described notification information regarding wireless communication with each of the wireless signal processing units 220, 230, and 240. The communication management unit 211 updates the management information regarding the wireless communication on the basis of the notification information from each of the wireless signal processing units 220, 230, and 240.

Further, in the management unit 210, the data distribution unit 212 distributes the data such as the LLC packet received from the LLC processing unit 200 to the wireless signal processing units 220, 230, and 240, and inputs the data from the LLC processing unit 200 to the corresponding wireless signal processing unit (one or more corresponding wireless signal processing units of 220, 230, and 240). In one example, in a case of receiving the traffic for which low latency is not required, the data distribution unit 212 specifies the link associated with the TID of the received traffic from the link set LS. Then, the data distribution unit 212 inputs the data (traffic) to the wireless signal processing unit (one or more corresponding wireless signal processing units 220, 230, and 240) corresponding to the specified link. Further, when receiving data from any of the wireless signal processing units 220, 230, and 240, the data distribution unit 212 inputs the received data such as the LLC packet to the LLC processing unit 200.

The wireless signal processing units (second wireless signal processing units) 220, 230, and 240 respectively correspond to the above-described A-STA 1, A-STA 2, and A-STA 3 that are the A-STA functions of the terminal 20. The wireless signal processing units 220, 230, and 240 have functional configurations similar to one another. Each of the wireless signal processing units 220, 230, and 240 can transmit the notification information input from the communication management unit 111 as a wireless signal. Further, each of the wireless signal processing units 220, 230, and 240 transmits the data such as the LLC packet received from the data distribution unit 112 as a wireless signal. In the example of FIG. 6, one antenna is provided corresponding to each of the wireless signal processing units 220, 230, and 240, but the wireless signal processing units 220, 230, and 240 may use a common antenna.

In a case of receiving the LLC packet as data from the data distribution unit 212, each of the wireless signal processing units 220, 230, and 240 adds a MAC header to the received LLC packet to generate a MAC frame (data frame). Further, in a case of transmitting the notification information input from the communication management unit 211, each of the wireless signal processing units 220, 230, and 240 generates the MAC frame (notification frame) including the input notification information. Then, each of the wireless signal processing units 220, 230, and 240 adds a preamble, a physical layer (PHY) header, and the like to the generated MAC frame to generate a wireless frame. Then, each of the wireless signal processing units 220, 230, and 240 performs a predetermined modulation operation for the generated wireless frame to convert the wireless frame into a wireless signal, and radiates (transmits) the wireless signal via an antenna. At this time, the predetermined modulation operation is performed similarly to the predetermined modulation operation in each of the wireless signal processing units 120, 130, and 140.

Moreover, each of the wireless signal processing units 220, 230, and 240 performs predetermined demodulation operation to convert the wireless signal from the AP 10 or the like received via an antenna into the wireless frame. The predetermined demodulation operation is performed similarly to the predetermined demodulation operation in each of the wireless signal processing units 120, 130, and 140. Then, each of the wireless signal processing units 220, 230, and 240 extracts the MAC frame from the wireless frame. In a case where the extracted MAC frame is a data frame, each of the wireless signal processing units 220, 230, and 240 extracts the data such as the LLC packet from the MAC frame, and inputs the extracted data to the data distribution unit 212. In a case where the extracted MAC frame is a notification frame, each of the wireless signal processing units 220, 230, and 240 extracts the notification information from the MAC frame, and inputs the extracted notification information to the communication management unit 211.

In the functional configurations illustrated in FIGS. 5 and 6, the communication management unit 111 of the AP 10 and the communication management unit 211 of the terminal 20 cooperate with each other to establish the link set LS including the plurality of links between the AP 10 and the terminal 20. Then, in the present embodiment, the communication management units 111 and 211 cooperate with each other to establish the multi-link by the link set LS between the AP 10 and the terminal 20. In the establishment of the link set LS and the multi-link, the communication management units 111 and 211 execute association processing and authentication processing subsequent to the association processing in response to a connection request from the terminal 20 to the AP 10, for example. At this time, any one of the wireless signal processing units 120, 130, and 140 (A-AP 1 to A-AP 3) of the AP 10 communicates with the corresponding one of the wireless signal processing units 220, 230, and 240 (A-STA 1 to A-STA 3) of the terminal 20.

Further, in the present embodiment, in the state in which the multi-link by the link set LS is established between the AP 10 and the terminal 20, the transmission and reception of the low-latency traffic is performed between the AP 10 and the terminal 20 by using the above-described R-TWT function. Hereinafter, processing performed in each of the AP 10 and the terminal 20 in relation to the transmission and reception of the low-latency traffic using the R-TWT function will be mainly described.

In the management unit 110 of the AP 10, the schedule control unit 113 of the communication management unit 111 allocates the service period to be the above-described R-TWT SP to each of the plurality of links constituting the link set LS. At this time, the SP is scheduled in an allocation pattern in which no break occurs in switching of the SP among the plurality of links of the link set LS. That is, in the transmission and reception using the R-TWT function, the allocation pattern for the SP is determined to a state in which the SP is allocated to any of the plurality of links of the link set LS at any time point. Therefore, in the allocation pattern for the determined SP, the next SP is started on another link of the link set LS at the same time as the SP ends in one link of the link set LS. Note that the allocation pattern for the SP is also referred to as “TWT hopping pattern”.

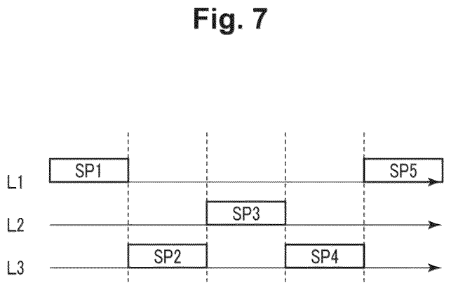

FIG. 7 is a schematic diagram illustrating an example of an allocation pattern for the R-TWT SP determined by the management unit 110 of the AP 10 in the present embodiment. In the example in FIG. 7, the links L1 to L3 constitute the link set LS. Then, an SP 1 and an SP 5 are allocated as the service periods to the link L1, an SP 3 is allocated as the service periods to the link L2, and an SP 2 and an SP 4 are allocated as the service periods to the link L3. In the example of FIG. 7, the SP 2 in the link L3 is started at the same time as an end of the SP 1 in the link L1, and the SP 3 in the link L2 is started at the same time as an end of the SP 2. Then, the SP 4 in the link L3 is started at the same time as an end of the SP 3, and the SP 5 in the link L1 is started at the same time as an end of the SP 4. Therefore, no break occurs in the switching of the SP among the links L1 to L3 constituting the link set LS, and the SP is allocated to any of the links L1 to L3 of the link set LS at any time point.

In one example, the schedule control unit 113 sets a certain time length from a start time point to an end time point of one SP. Then, the SP having a certain time length is sequentially allocated to the plurality of links of the link set LS. Further, in each of the plurality of links of the link set LS, in a case where there is an already reserved time zone, the already reserved time zone becomes a period in which the low-latency traffic is non-transmittable. For example, it is assumed that the SP allocated by the above-described TWT hopping pattern is used for transmission and reception of the low-latency traffic that is non-periodically generated, and the R-TWT SP used for transmission and reception of the low-latency traffic that is periodically generated is allocated as the service period to any of the plurality of links of the link set LS separately from the SP of the TWT hopping pattern. In this case, in the link to which the SP for the low-latency traffic that is periodically generated, the SP for the low-latency traffic that is periodically generated corresponds to the non-transmittable period. Further, in each of the plurality of links of the link set LS, a reservation period using the same channel as the link by a basic service set (BSS) different from a BSS of the AP 10, a reservation period of a network allocation vector (NAV), and the like also correspond to the non-transmittable period.

Therefore, in one example, the schedule control unit 113 of the communication management unit 111 inputs, to each of the wireless signal processing units 120, 130, and 140 (A-AP 1 to A-AP 3), a request for a period during which the low-latency traffic is non-transmittable in the corresponding link (for example, one corresponding link of L1 to L3). Then, the schedule control unit 113 receives a response to the request from each of the wireless signal processing units 120, 130, and 140, and allocates the SP to each of the plurality of links of the link set LS on the basis of the received response. At this time, in each of the plurality of links, timing of the allocated SP is adjusted to a state in which no collision with the non-transmittable period occurs. The schedule control unit 113 allocates the SP to a state in which no collision with the non-transmittable period occurs in each of the plurality of links by, for example, replacing the allocation of the SP with another link of the link set LS or shortening the time length of the SP.

In one example, in the allocation of the SP, the schedule control unit 113 allocates the SP to a state where the allocation time of the SP is equal to one another in the plurality of links of the link set LS. In another example, the schedule control unit 113 acquires a ratio of the non-transmittable period in the corresponding link from each of the wireless signal processing units 120, 130, and 140. Then, the schedule control unit 113 allocates the SP to a state in which a ratio of an SP allocation time becomes smaller for the link having a larger ratio of the non-transmittable period. The schedule control unit 113 outputs schedule information indicating the allocation pattern for the SP to the plurality of links determined as described above to the wireless signal processing unit 120, 130, and 140 and the data distribution unit 112. As a result, the schedule information is input as the notification information from the communication management unit 111 to each of the wireless signal processing units 120, 130, and 140.

The non-periodically generated low-latency traffic can be input from the LLC processing unit 100 to the data distribution unit 112. The data distribution unit 112 distributes the low-latency traffic received from the LLC processing unit 100 to the wireless signal processing unit 120, 130, and 140 on the basis of the schedule information from the communication management unit 111. In a case where the data distribution unit 112 receives the non-periodically generated low-latency traffic, the data distribution unit 112 inputs the received low-latency traffic to the wireless signal processing unit (corresponding one of 120, 130, and 140) corresponding to the link to which the SP is allocated in real time. At this time, the data distribution unit 112 specifies the link to which the SP is allocated at the timing when the low-latency traffic is received on the basis of the allocation pattern for the SP indicated by the schedule information. Then, the data distribution unit 112 outputs the low-latency traffic to the wireless signal processing unit (corresponding one of 120, 130, and 140) corresponding to the specified link. As a result, the wireless signal of the low-latency traffic is transmitted from the AP 10 through the link to which the SP is allocated in real time.

In one example, the data distribution unit 112 compares a time required for transmitting the received low-latency traffic with a remaining time until the end time point of the SP set in real time. Then, as a result of the comparison, in a case where it is determined that the remaining time of the SP set in real time is not sufficient for transmission of the low-latency traffic, the data distribution unit 112 outputs the low-latency traffic to the wireless signal processing unit (corresponding one of 120, 130, and 140) corresponding to the link to which the next SP is to be allocated. As a result, the wireless signal of the low-latency traffic is transmitted from the terminal 20 through the link to which the SP next to the SP set in real time is allocated.

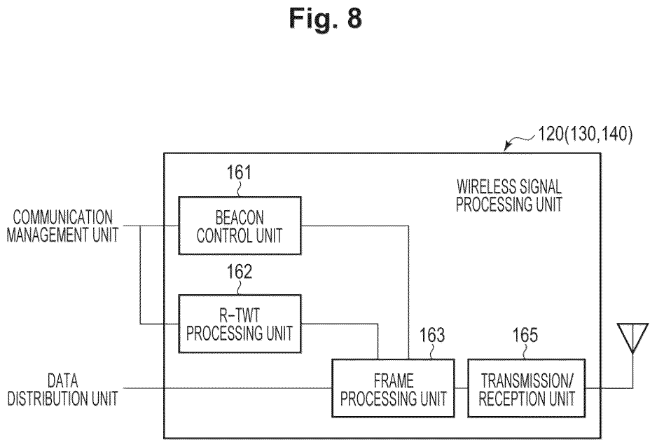

FIG. 8 is a block diagram illustrating an example of a functional configuration of one of the wireless signal processing units 120, 130, and 140 (A-AP 1 to A-AP 3) of the AP 10 in the present embodiment. Here, FIG. 8 illustrates a functional configuration of the wireless signal processing unit 120, and the wireless signal processing unit 120 will be mainly described in the following description. Note that each of the wireless signal processing units 130 and 140 has a functional configuration similar to the wireless signal processing unit 120, and performs processing similar to the wireless signal processing unit 120. As illustrated in FIG. 8 and the like, the wireless signal processing unit 120 includes a beacon control unit 161, an R-TWT processing unit 162, a frame processing unit 163, and a transmission/reception unit 165.

The beacon control unit 161 transmits a beacon through the corresponding link. The beacon control unit 161 generates notification information to be provided in notification in the beacon on the basis of the schedule information from the schedule control unit 113, and inputs the generated notification information to the frame processing unit 163. Then, the frame processing unit 163 generates a beacon frame including the notification information from the beacon control unit 161 as a notification frame. The beacon frame indicates the allocation pattern for the SP and the like included in the schedule information. The wireless signal processing unit 120 or the like converts the beacon frame into a wireless signal, and transmits the converted wireless signal as a beacon through the transmission/reception unit 165. As a result, the allocation pattern for the SP determined by the schedule control unit 113 is provided in notification.

In one example, the beacon control unit 161 extracts only the information regarding the SP allocated to the corresponding link from the allocation pattern for the SP indicated by the schedule information. Then, in the beacon including the beacon frame, start time, duration, and the like are provided in notification for each SP (R-TWT SP) allocated to the corresponding link. For example, in the beacon provided in notification by the beacon control unit 161 or the like of the wireless signal processing unit 120 (A-AP 1), the start time, the duration, and the like are provided in notification for each SP allocated to the link L1.

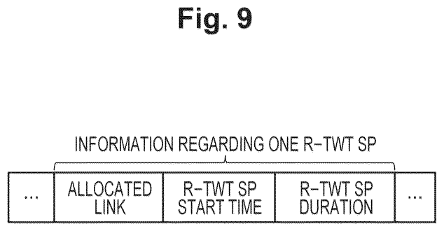

FIG. 9 is a schematic diagram illustrating an example of a format of the beacon frame generated by the beacon control unit 161 and the frame processing unit 163 in the AP 10 according to the present embodiment. In the example of FIG. 9, information regarding all the SPs allocated to the plurality of links of the link set LS in the schedule information is indicated by the beacon including the beacon frame. In the present example, for each of all the SPs allocated to the link set LS, the start time, the duration, the identifier of the allocated link, and the like are provided in notification by the beacon. In one example, each of all the wireless signal processing units 120, 130, and 140 provides notification of the information regarding all the SPs allocated to the plurality of links of the link set LS by the beacon.

In another example, one of the plurality of links of the link set LS is set as a primary link. Then, the wireless signal processing unit (corresponding one of 120, 130, and 140) corresponding to the primary link provides notification of the information regarding all the SPs allocated to the plurality of links of the link set LS by the beacon. Note that, in a case where the primary link is set, the wireless signal processing unit corresponding to each of the links other than the primary link may provide notification of only the information regarding the SP allocated to the corresponding link by the beacon. As described above, in the present embodiment, the beacon is transmitted from one or more of the wireless signal processing units 120, 130, and 140. As a result, the schedule information indicating the allocation pattern for the SP determined by the schedule control unit 113 is provided in notification through one or more of the plurality of links of the link set LS.

Further, each of the wireless signal processing units 120, 130, and 140 may receive a beacon or the like from an AP other than the AP 10, and the received beacon or the like from the AP other than the AP 10 may include setting information of an SP such as an R-TWT SP. In a case where the setting information of the SP is included in the beacon or the like from the AP other than the AP 10, the beacon control unit 161 notifies the schedule control unit 113 of the communication management unit 111 of the setting information of the SP or the like as the notification information. The schedule control unit 113 determines the non-transmittable period in each of the plurality of links of the link set LS on the basis of the setting information or the like provided in notification from the beacon control unit 161.

The R-TWT processing unit 162 specifies the SP allocated to the corresponding link from the allocation pattern for the SP indicated by the schedule information. Then, the R-TWT processing unit 162 causes a trigger to be transmitted through the corresponding link at each start time of the SP allocated to the corresponding link. For example, in the wireless signal processing unit 120, the R-TWT processing unit 162 causes the trigger to be transmitted through the link L1 at each start time of the SP allocated to the link L1. In the transmission of the trigger, the R-TWT processing unit 162 generates a trigger frame in cooperation with the frame processing unit 163. Then, the wireless signal processing unit 120 or the like converts the trigger frame into a wireless signal, and transmits the converted wireless signal as a trigger through the transmission/reception unit 165. In the trigger including the trigger frame, the duration or end time of the SP to be started is indicated. In addition, in the trigger, information regarding the SP next to the SP to be started may be provided in notification. As the information regarding the next SP of the SP to be started, the start time and the duration of the next SP, the identifier of the link to which the next SP is allocated, and the like are provided in notification.

Further, each of the wireless signal processing units 120, 130, and 140 may receive setting information of an SP such as an R-TWT SP different from the SP allocated by the above-described TWT hopping pattern from the terminal 20 or a terminal other than the terminal 20. For example, in a case where low-latency traffic periodically generated is transmitted from a terminal other than the terminal 20 to the AP 10, an SP different from the SP allocated by the TWT hopping pattern may be set, and the low-latency traffic from the terminal may be preferentially transmitted. In a case of receiving the setting information of an SP different from the SP allocated by the TWT hopping pattern, the R-TWT processing unit 162 notifies the schedule control unit 113 of the communication management unit 111 of the received setting information of the SP and the like as the notification information. The schedule control unit 113 determines the non-transmittable period in each of the plurality of links of the link set LS on the basis of the setting information or the like provided in notification from the R-TWT processing unit 162.

The frame processing unit 163 generates the MAC frame to serve as the data frame by, for example, adding the MAC header to the LLC packet. Then, the frame processing unit 163 generates the MAC frame to serve as the notification frame including the beacon frame and the trigger frame described above. Further, the frame processing unit 163 extracts the data such as the LLC packet or the notification information from the MAC frame obtained by converting the received wireless signal.

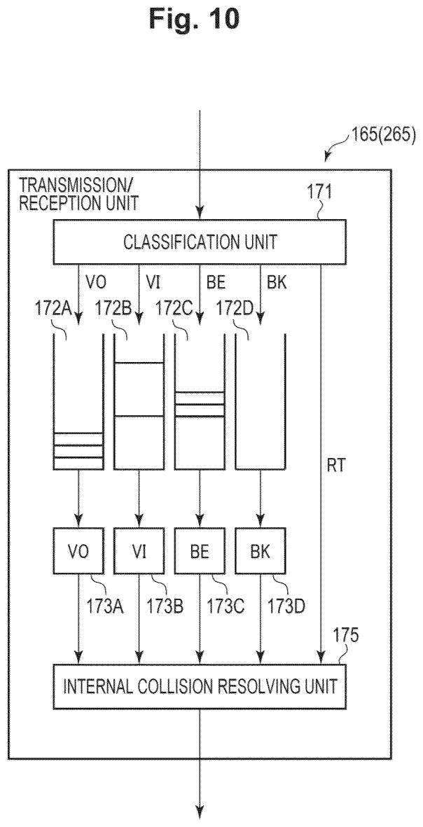

FIG. 10 is a block diagram illustrating an example of a functional configuration of the transmission/reception unit 165 of the wireless signal processing unit 120 in the AP 10 according to the present embodiment. Here, in the following description, the transmission/reception unit 165 of the wireless signal processing unit 120 will be mainly described. Note that the respective transmission/reception units 165 of the wireless signal processing units 130 and 140 have a functional configuration similar to the transmission/reception unit 165 of the wireless signal processing unit 120, and performs processing similar to the transmission/reception unit 165 of the wireless signal processing unit 120. In each of the wireless signal processing units 120, 130, and 140, the transmission/reception unit 165 functions as a channel access function. As illustrated in FIG. 10, the transmission/reception unit 165 includes, for example, a classification unit. 171, queues 172A to 172D, carrier sensing execution units 173 A to 173D, and an internal collision resolving unit 175.

In the example of FIG. 10, when the data frame (MAC frame) of traffic for which low latency is not requested or the like is input to the transmission/reception unit 165, the classification unit 171 classifies the input data frame into a plurality of access categories on the basis of the TID included in the MAC header. At this time, the traffic for which low latency is not requested is classified into any of the access categories other than RT. Then, the classification unit 171 inputs the data frame to one corresponding access category of the queues 172A to 172D. As a result, the data frame is input to the queue (corresponding one of 172A to 172D) corresponding to the access category to which the data frame is classified. In the example in FIG. 10, data frames whose access categories are VO, VI, BE, and BK are respectively inputted to the queues 172A, 172B, 172C, and 172D.

Each of the queues 172A to 172D buffers the inputted data frame. In the example in FIG. 10, the queues 172A, 172B, 172C, and 172D respectively buffer the data frames whose access categories are VO, VI, BE, and BK. The carrier sensing execution units 173A, 173B, 173C, and 173D are respectively provided corresponding to the queues 172A, 172B, 172C, and 172D. Each of the carrier sensing execution units 173A to 173D executes carrier sensing based on CSMA/CA as the channel access processing in accordance with access parameters set in advance. Each of the carrier sensing execution units 173A, 173B, 173C, and 173D performs carrier sensing with VO, VI, BE, and BK as corresponding access categories.

The access parameters are set for each access category, and are set to a state in which transmission of a wireless signal is prioritized in the order of VO, VI, BE, and BK. As the access parameters, for example, CWmin, CWmax, Arbitration Inter Frame Space (AIFS), and Transmission Opportunity (TXOP) Limit are used. CWmin and CWmax respectively indicate a minimum value and a maximum value of a contention window, which are parameters used to set a transmission wait time for collision avoidance. AIFS indicates a fixed transmission wait time set for each access category. TXOPLimit indicates an upper limit value of a channel occupancy time TXOP. Therefore, for the access category in which the values of CWmin, CWmax, and AIFS are set to be shorter, the transmission right can be more easily obtained, and for the access category in which the value of TXOPLimit is set to be larger, an amount of data transmitted with one transmission right is larger.

Each of the carrier sensing execution units 173A to 173D checks, by carrier sensing, a situation of a corresponding one to the wireless signal processing unit 120 of the plurality of links constituting the link set LS. At this time, as long as the channel corresponding to the link whose situation is being checked is in a busy state, that is, until the channel corresponding to the link whose situation is being checked becomes in an idle state, each of the carrier sensing execution units 173A to 173D continues the carrier sensing. Then, when the channel corresponding to the link whose situation is being checked becomes in an idle state and the transmission right is obtained in the link whose situation is being checked, each of the carrier sensing execution units 173A to 173D extracts the data frame from the corresponding one of the queues 172A to 172D. Then, each of the carrier sensing execution units 173A to 173D converts the data frame into a wireless signal and transmits the converted wireless signal through the link for which the transmission right has been obtained.

In a case where a plurality of carrier sensing execution units of the carrier sensing execution units 173A to 173D obtains the transmission right on the link corresponding to the wireless signal processing unit 120, the internal collision resolving unit 175 prevents collision in data transmission. That is, the internal collision resolving unit 175 adjusts transmission timing of each of a plurality of pieces of data for which the transmission right has been obtained in the A-AP 1, and sequentially transmits the data of the access category with high priority.

Further, the data frame (MAC frame) of the non-periodically generated low-latency traffic is input to the transmission/reception unit 165, and the above-described trigger frame is input at each start time of the SP allocated to the corresponding link. The classification unit 171 classifies the data frame of the low-latency traffic and the trigger frame into the access category of the RT. Then, the transmission/reception unit 165 performs transmission processing such as the channel access processing in the state in which the data frame, the trigger frame, and the like classified into the access category of the RT are transmitted in preference to the data frames of the other access categories. In one example, the access parameters in the carrier sensing are set to the state in which the data frame, the trigger frame, and the like classified into the RT are transmitted in preference to the data frames classified into the other access categories.

In another example, the trigger frame is classified into the access category of VO having the highest transmission priority among the VO, VI, BE, and BK. Then, for the trigger frame, the carrier sensing is performed with the access parameters set for the VO, and the trigger frame is inserted into a head of another data frame buffered in the queue 172A of the VO. Then, when the carrier sensing execution unit 173A obtains the transmission right, the trigger frame is extracted from the queue 172A and transmitted in advance of the other data frames buffered in the queue 172A.

Further, in a case of determining that the SP (R-TWT SP) is allocated to the corresponding link in real time, the transmission/reception unit 165 may transmit the data frame of the non-periodically generated low-latency traffic without performing the channel access processing such as carrier sensing. In this case, the transmission/reception unit 165 determines whether the SP is allocated to the corresponding link in real time on the basis of, for example, the timing of transmitting the trigger of the start time of the SP.

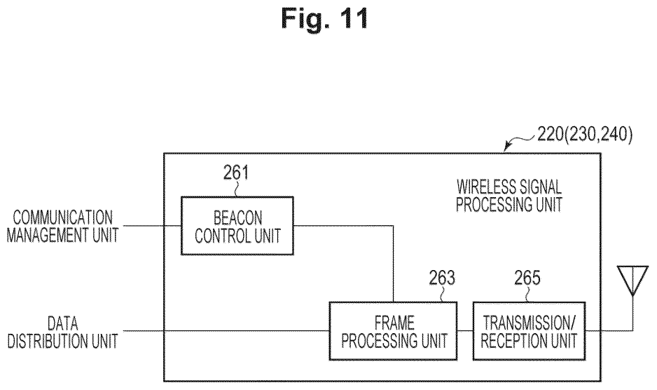

FIG. 11 is a block diagram illustrating an example of a functional configuration of one of the wireless signal processing units 220, 230, and 240 (A-STA 1 to A-STA 3) of the terminal 20 in the present embodiment. Here, FIG. 11 illustrates a functional configuration of the wireless signal processing unit 220, and the wireless signal processing unit 220 will be mainly described in the following description. Note that each of the wireless signal processing units 230 and 240 has a functional configuration similar to the wireless signal processing unit 220, and performs processing similar to the wireless signal processing unit 220.

As illustrated in FIG. 11 and the like, the wireless signal processing unit 220 includes a beacon processing unit 261, a frame processing unit 263, and a transmission/reception unit 265. The transmission/reception unit 265 converts the received wireless signal into a MAC frame such as a data frame or a notification frame. Further, the transmission/reception unit 265 converts the MAC frame input from the frame processing unit 263 into a wireless signal and transmits the wireless signal. The functional configuration of the transmission/reception unit 265 is similar to the functional configuration of each of the transmission/reception units 165 of the wireless signal processing unit 120, 130, and 140 of the AP 10 illustrated in FIG. 10 and the like. Further, the transmission/reception unit 265 performs the transmission processing such as the channel access processing similarly to the transmission/reception unit 165 of the AP 10.

The frame processing unit 263 generates the MAC frame to serve as the data frame by, for example, adding the MAC header to the LLC packet. Furthermore, the data frame or the notification frame is input as the MAC frame from the transmission/reception unit 265 to the frame processing unit 263. In a case where the data frame is input from the transmission/reception unit 265, the frame processing unit 263 extracts the data such as the LLC packet from the input MAC frame. Then, the frame processing unit 263 outputs the extracted data to the data distribution unit 212 of the management unit 210.

Further, in a case where the beacon frame is input as the notification frame from the transmission/reception unit 265, the frame processing unit 263 extracts the notification information included in the beacon frame, and outputs the extracted notification information to the beacon processing unit 261. Then, the beacon processing unit 261 outputs the notification information extracted from the beacon frame to the communication management unit 211 (schedule control unit 213). The notification information extracted from the beacon frame includes the allocation pattern for the SP (R-TWT SP) determined by the schedule control unit 113 of the AP 10, and includes the above-described schedule information indicating the allocation pattern for the SP determined by the schedule control unit 113.

Further, in a case where the trigger frame obtained by converting the trigger received at each time of the SP allocated to the corresponding link is input as the notification frame from the transmission/reception unit 265, the frame processing unit 263 extracts the notification information included in the trigger frame. The notification information included in the trigger frame includes the duration or the end time of the SP to be started. The frame processing unit 263 sets a duration of the SP started in real time on the basis of the extracted notification information. Furthermore, in a case where the trigger frame includes the information regarding the SP next to the SP to be started as the notification information, the frame processing unit 263 outputs the information regarding the next SP to the beacon processing unit 261 as the notification information. Then, the beacon processing unit 261 outputs the information regarding the next SP extracted from the trigger frame to the communication management unit 211 (schedule control unit 213).

The notification information is input from each beacon processing unit 261 of the wireless signal processing units 220, 230, and 240 to the schedule control unit 213 of the communication management unit 211 of the terminal 20 illustrated in FIG. 6 and the like. The schedule information indicating the allocation pattern for the SP determined by the schedule control unit 113 of the AP 10, the information for the next SP included in the trigger, and the like are input as the notification information to the schedule control unit 213. Then, in the management unit 210, the schedule control unit 213 outputs the schedule information indicating the allocation pattern for the SP (R-TWT SP) in the plurality of links of the link set LS to the data distribution unit 212.

In one example, the beacon is transmitted from the AP 10 through each of the plurality of links constituting the link set LS, and the schedule information including the allocation pattern for the SP is indicated in each of the transmitted beacons. In this case, the schedule control unit 213 sets or updates the schedule information for the SP including the allocation pattern for the SP on the basis of the schedule information provided in notification by the beacon through each of the plurality of links of the link set LS. In another example, the beacon is transmitted from the AP 10 only through the primary link, which is one of the plurality of links of the link set LS, and the beacon transmitted through the primary link indicates the schedule information including the allocation pattern for the SP. In this case, the schedule control unit 213 sets or updates the schedule information for the SP including the allocation pattern for the SP on the basis of the schedule information provided in notification by the beacon through the primary link.

Further, it is assumed that the terminal 20 receives the trigger for the SP started in real time through the corresponding link, and the information regarding the next SP is indicated in the received trigger. In this case, the information regarding the next SP indicated in the received trigger is input to the schedule control unit 213 (communication management unit 211) from the corresponding wireless signal processing unit (corresponding one of 220, 230, and 240). Then, the schedule control unit 213 sets or updates the schedule information regarding the SP including the allocation pattern for the SP on the basis of the input information regarding the next SP. When having set or updated the schedule information for the SP as described above, the schedule control unit 213 inputs the set or updated schedule information to the data distribution unit 212.

The non-periodically generated low-latency traffic can be input from the LLC processing unit 200 to the data distribution unit 212. The data distribution unit 212 distributes the low-latency traffic received from the LLC processing unit 200 to the wireless signal processing units 220, 230, and 240 on the basis of the schedule information regarding the SP from the communication management unit 211 (schedule control unit 213). In a case where the data distribution unit 212 receives the non-periodically generated low-latency traffic, the data distribution unit 212 inputs the received low-latency traffic to the wireless signal processing unit (corresponding one of 220, 230, and 240) corresponding to the link to which the SP is allocated in real time. At this time, the data distribution unit 212 specifies the link to which the SP is allocated at the timing when the low-latency traffic is received on the basis of the allocation pattern for the SP indicated by the schedule information. Then, the data distribution unit 212 outputs the low-latency traffic to the wireless signal processing unit (corresponding one of 220, 230, and 240) corresponding to the specified link. As a result, the wireless signal of the low-latency traffic is transmitted from the terminal 20 through the link to which the SP is allocated in real time.

In one example, the data distribution unit 212 compares a time required for transmitting the received low-latency traffic with a remaining time until the end time point of the SP set in real time. Then, as a result of the comparison, in a case where it is determined that the remaining time of the SP set in real time is not sufficient for transmission of the low-latency traffic, the data distribution unit 212 outputs the low-latency traffic to the wireless signal processing unit (corresponding one of 220, 230, and 240) corresponding to the link to which the next SP is to be allocated. As a result, the wireless signal of the low-latency traffic is transmitted from the terminal 20 through the link to which the SP next to the SP set in real time is allocated.

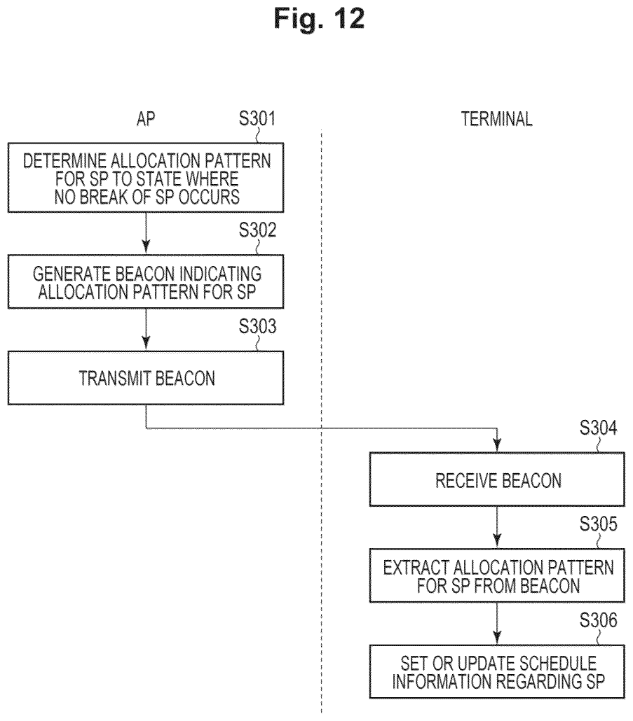

FIG. 12 is a flowchart schematically illustrating an example of processing performed by the AP 10 and the terminal 20 in the present embodiment. The processing of FIG. 12 is performed at each time the allocation pattern for the SP (the schedule information for the SP) is newly determined. When the processing of the example of FIG. 12 is started, the schedule control unit 113 of the management unit (first management unit) 110 of the AP 10 determines the allocation pattern for the SP in the state in which no break occurs in the switching of the SP among the plurality of links of the link set LS (S301). The determination of the allocation pattern for the SP is performed as described above. Then, the communication management unit 111 of the management unit 110 generates the beacon indicating the determined allocation pattern for the SP in cooperation with one or more of the wireless signal processing units 120, 130, and 140 (S302). Then, one or more of the wireless signal processing units (first wireless signal processing units) 120, 130, and 140 transmits the generated beacon through the corresponding one of the plurality of links (S303). The generation and transmission of the beacon is performed as described above.

Then, in the terminal 20, one or more of the wireless signal processing units (second wireless signal processing units) 220, 230, and 240 receive the beacon (S304). Then, the wireless signal processing unit (corresponding one or more of 220, 230, and 240) that has received the beacon extracts the allocation pattern for the SP from the received beacon (S305). Then, the management unit (second management unit) 210 sets or updates the schedule information for the SP on the basis of the extracted allocation pattern for the SP (S306). The extraction of the allocation pattern for the SP from the beacon and the setting or update of the schedule information for the SP are performed as described above.

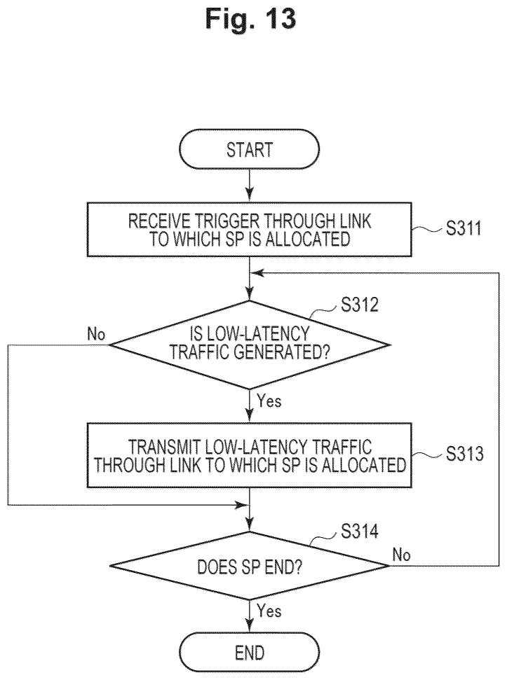

FIG. 13 is a flowchart schematically illustrating an example of processing performed in one SP by the terminal 20 according to the present embodiment. The processing of the example of FIG. 13 is performed by the terminal 20 in every SP. Further, FIG. 13 illustrates only the processing related to the non-periodically generated low-latency traffic. In the processing of the example of FIG. 13, the corresponding one of the wireless signal processing units 220, 230, and 240 of the terminal 20 receives the trigger from the AP 10 through the link to which the SP is allocated at the same time with the start time of the SP (S311). Then, when the low-latency traffic is non-periodically generated in the terminal 20 (S312—Yes), the data distribution unit 212 of the management unit 210 inputs the generated low-latency traffic to the wireless signal processing unit (corresponding one of 220, 230, and 240) corresponding to the link to which the SP is allocated, and causes the low-latency traffic to be transmitted through the link to which the SP is allocated (S313). Then, the processing proceeds to S314. On the other hand, in a case where the low-latency traffic is not generated (S312—No), the processing proceeds to S314 without performing the processing of S313. Then, unless the SP ends (S314), the processing returns to S312, and the processing in and after 6312 is sequentially performed.

Note that, in one example, in a case where the low-latency traffic is non-periodically generated, the time required for transmitting the generated low-latency traffic may be compared with the remaining time until the end time point of the SP set in real time as described above. In this case, the link for transmitting the low-latency traffic is determined as described above on the basis of a comparison result. Further, in one SP, in the AP 10, the corresponding one of the wireless signal processing units 120, 130, and 140 transmits the trigger through the link to which the SP is allocated at the same time as the start time of the SP, instead of the processing of S311. Then, the AP 10 performs processing similar to S312 to S314.

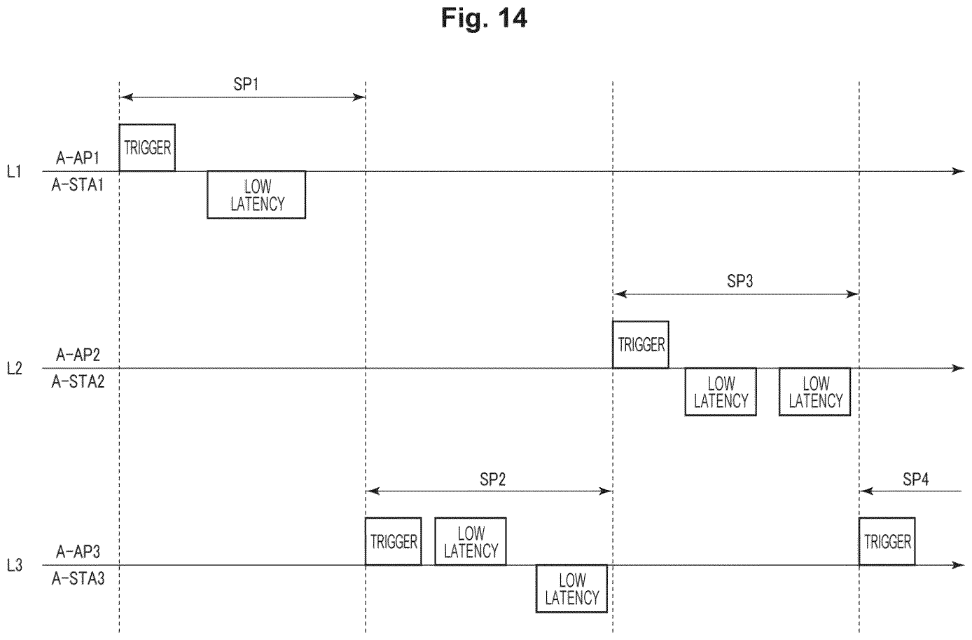

FIG. 14 is a schematic diagram illustrating an example of temporal changes in the communication state through the link set LS between the AP 10 and the terminal 20 in the communication system 1 according to the present embodiment. In the example of FIG. 14, the SP that is the R-TWT SP is allocated to each of the plurality of links L1 to L3 of the link set LS, similarly to the example of FIG. 7. Further, FIG. 14 illustrates only transmission and reception related to the non-periodically generated low-latency traffic. In the example of FIG. 14, at the start time of the SP 1, the wireless signal processing unit 120 (A-AP 1) of the AP 10 transmits the trigger through the link L1 to which the SP 1 is allocated. Then, the low-latency traffic is non-periodically generated in the terminal 20 during the SP 1, and the wireless signal processing unit 220 (A-STA 1) of the terminal 20 transmits the non-periodically generated low-latency traffic through the link L1 until the end time of the SP 1.

Further, when the SP 2 is started at the same time as the end of the SP 1, the wireless signal processing unit 140 (A-AP 3) of the AP 10 transmits the trigger through the link L3 to which the SP 2 is allocated. In addition, in the example of FIG. 14, the low-latency traffic is non-periodically generated in each of the AP 10 and the terminal 20 during the SP 2. Then, each of the wireless signal processing unit 140 of the AP 10 and the wireless signal processing unit 240 (A-STA 3) of the terminal 20 transmits the non-periodically generated low-latency traffic through the link L3. Further, when the SP 3 is started at the same time as the end of the SP 2, the wireless signal processing unit 130 (A-AP 2) of the AP 10 transmits the trigger through the link L2 to which the SP 3 is allocated. Further, in the example of FIG. 14, the low-latency traffic is non-periodically generated twice in the terminal 20 during the SP 3. Then, the wireless signal processing unit 230 (A-STA 2) of the terminal 20 transmits, through the link L2, each piece of non-periodically generated low-latency traffic generated twice. Further, when the SP 4 is started at the same time as the end of the SP 3, the wireless signal processing unit 140 (A-AP 3) of the AP 10 transmits the trigger through the link L3 to which the SP 4 is allocated.

As described above, in the present embodiment, the management unit (first management unit) 110 of the AP 10 switches the link for transmitting and receiving the low-latency traffic to and from the terminal 20 among the plurality of links of the link set LS on the basis of the schedule information indicating the determined allocation pattern for the SP. Then, in the present embodiment, the management unit 110 switches the link for transmitting and receiving the non-periodically generated low-latency traffic by switching the wireless signal processing unit (first wireless signal processing unit) for inputting the low-latency traffic among the plurality of wireless signal processing units 120, 130, and 140 (A-AP 1 to A-AP 3). Further, in the present embodiment, the management unit (second management unit) 210 of the terminal 20 sets or updates the schedule information for the SP on the basis of the beacon from the AP 10 or the like, and switches the link for transmitting and receiving the low-latency traffic to and from the AP 10 among the plurality of links of the link set LS on the basis of the set or updated schedule information. Then, in the present embodiment, the management unit 210 switches the link for transmitting and receiving the non-periodically generated low-latency traffic by switching the wireless signal processing unit (second wireless signal processing unit) for inputting the low-latency traffic among the plurality of wireless signal processing units 220, 230, and 240 (A-STA 1 to A-STA 3).

Here, in a situation where a terminal 20α other than the terminal 20 can wirelessly communicate with the AP 10, the terminal 20α performs the following processing. Note that, in the following description, for components of the terminal 20α, “α” is added to similar reference numerals to those of the components of the terminal 20. Similarly to the terminal 20, the terminal 20α also includes a management unit 210α and a plurality of wireless signal processing units 220α, 230α, and 240α, and the management unit 210α includes a communication management unit 213α including a schedule control unit 211α and a data distribution unit 212α. Each of the wireless signal processing units 220α, 230α, and 240α includes a beacon processing unit 261α, a frame processing unit 263α, and a transmission/reception unit 265α.

Also in the terminal 20α, the wireless signal processing unit (corresponding one or more of 220α, 230α, and 240α) that has received the beacon from the AP 10 extracts the allocation pattern for the SP from the received beacon, and the management unit 210α sets or updates the schedule information for the SP on the basis of the extracted allocation pattern for the SP. Further, the beacon processing unit 261α of each of the wireless signal processing units 220α, 230α, and 240α acquires the information regarding the SP allocated to the corresponding link from the schedule information and the like. Further, in each of the wireless signal processing units 220α, 230α, and 240α, the transmission/reception unit 265α controls the transmission through the corresponding link in a state in which the transmission of traffic other than the low-latency traffic non-periodically generated in the corresponding link does not overlap with the allocated SP.

Further, in the terminal 20α, the data distribution unit 212α distributes the traffic to the wireless signal processing units 220α, 230α, and 240α regardless of the schedule information for the SP. In one example, the data distribution unit 212α specifies a link associated with the TID of the received traffic and inputs the traffic (data) to the wireless signal processing unit (corresponding one or more of the 220α, 230α, and 240α) corresponding to the specified link.

As described above, in the present embodiment, the management unit 110 of the AP 10 allocates the SP that gives priority to the transmission and reception of the low-latency traffic to each of the plurality of links of the link set LS in the allocation pattern in which no break occurs in the switching of the SP among the plurality of links. Therefore, by performing the communication control on the basis of the determined allocation pattern for the SP, the AP 10 can transmit the non-periodically generated low-latency traffic through the link to which the SP is allocated even if the low-latency traffic is non-periodically generated at any timing.

Furthermore, in the present embodiment, the management unit 110 of the AP 10 provides notification of the schedule information regarding the SP indicating the determined allocation pattern for the SP by transmitting the beacon. Therefore, by performing the communication control on the basis of the schedule information for the SP provided in notification from the AP 10, the terminal 20 can transmit the non-periodically generated low-latency traffic through the link to which the SP is allocated even if the low-latency traffic is non-periodically generated at any timing.

As described above, in the present embodiment, it is possible to transmit and receive the low-latency traffic in the state of satisfying the delay request even if the low-latency traffic is non-periodically generated in the wireless communication between the AP 10 and the terminal 20. As a result, it is possible to reduce delay and jitter even in the transmission and reception of the non-periodically generated low-latency data. Further, in the present embodiment, the SP is allocated to each of the plurality of links of the link set LS, and the SP is switched among the plurality of links. For this reason, the utilization efficiency of the plurality of links of the link set LS is increased and the frequency utilization efficiency is increased as compared with a case where the transmission and reception of the non-periodically generated low-latency traffic is allocated to one link. Therefore, the decrease in the frequency utilization efficiency is appropriately suppressed.

Further, in the present embodiment, each of the wireless signal processing units 120, 130, and 140 of the AP 10 transmits the trigger at each start time of the SP allocated to the corresponding one of the plurality of links of the link set LS. Then, in one example, each of the wireless signal processing units 120, 130, and 140 provides notification of the information of the SP next to the SP started by the trigger by transmitting the trigger. In this case, the terminal 20 can sequentially acquire the schedule information regarding the SP by receiving the trigger even in a case where the beacon cannot be received.

### Modification

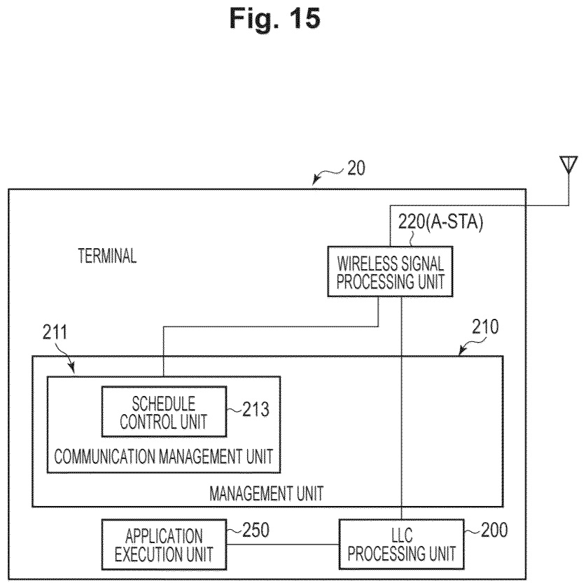

FIG. 15 is a block diagram illustrating an example of a functional configuration of the terminal 20 according to one modification. As illustrated in FIG. 15, the terminal 20 of the present modification is provided with only one wireless signal processing unit 220 serving as the A-STA function. Even in the present modification, in the wireless connection between the AP 10 and the terminal 20, the link set LS including a plurality of links is established. In the present modification, each of the plurality of links of the link set LS is established by using a corresponding one of the plurality of A-AP functions (wireless signal processing units 120, 130, and 140) of the AP 10 and the A-STA function (wireless signal processing unit 220) of the terminal 20. Accordingly, only one A-STA function provided in the terminal 20 is used to establish all the links constituting the link set LS.

Even in the present modification, each of the plurality of A-AP functions (first wireless signal processing units) of the AP 10 can perform wireless communication through a corresponding one of the plurality of links of the link set LS. Note that, in the present modification, in the terminal 20, the only one A-STA function (second wireless signal processing unit) can perform wireless communication using a plurality of links of the link set LS. Then, the wireless signal processing unit 220 serving as the A-STA function selects one of the plurality of links on the basis of a command or the like from the communication management unit 211 of the management unit 210, and transmits a wireless signal through the selected link. Therefore, in the present modification, the wireless signal processing unit 220 switches the link for transmitting the wireless signal among the plurality of links of the link set LS on the basis of the command or the like from the communication management unit 211. Further, in the present modification, the wireless signal processing unit 220 cannot transmit data by the plurality of links in parallel to one another. That is, at the same timing, the wireless signal processing unit 220 can transmit the traffic or the like as a wireless signal to the AP 10 only through one of the plurality of links of the link set LS. Note that the wireless signal processing unit 220 of the terminal 20 may be able to receive the wireless signals by the plurality of links of the link set LS in parallel to one another, or may be able to receive the wireless signal through only one of the plurality of links of the link set LS at the same timing.

Here, the terminal provided with only one A-STA function having the above-described function is also referred to as a “single radio (SR) terminal”. Then, the function to establish the link set LS between the AP 10 and the terminal 20, which is the SR terminal, as described above and perform the wireless communication between the AP 10 and the terminal 20 using the link set LS as described above is also referred to as an “enhanced multi link single radio (EMLSR) function”.

In the present modification, the wireless signal processing unit 220 of the terminal 20 receives the beacon from the AP 10. Then, the beacon processing unit 261 of the wireless signal processing unit 220 extracts the allocation pattern for the SP from the received beacon, similarly to the above-described embodiment and the like. Then, in the management unit 210, the schedule control unit 213 of the communication management unit 211 sets or updates the schedule information for the SP on the basis of the extracted allocation pattern for the SP, similarly to the above-described embodiment and the like. In one example of the present modification, the wireless signal processing unit 220 can receive the wireless signal through only one of the plurality of links in the link set LS at the same timing. Then, the beacon from the AP 10 is provided in notification only through the primary link among the plurality of links of the link set LS. In this case, at the timing when the beacon is transmitted from the AP 10, the communication management unit 211 inputs the command to the wireless signal processing unit 220 or the like to switch the link in which the wireless signal processing unit 220 receives the wireless signal to the primary link. As a result, the terminal 20 can appropriately receive the beacon from the AP 10, and the schedule information for the SP is set or updated.

Furthermore, in the present modification, the communication management unit 211 inputs the command to the wireless signal processing unit 220 or the like on the basis of the set or updated schedule information for the SP, thereby switching the link in which the wireless signal processing unit 220 transmits the wireless signal among the plurality of links of the link set LS. At this time, the link in which the wireless signal processing unit 220 transmits the wireless signal is switched corresponding to the allocation of the SP in the link set LS in the schedule information. Accordingly, even in the present modification, similarly to the above-described embodiment and the like, the link for transmitting and receiving the low-latency traffic to and from the AP 10 is switched among the plurality of links on the basis of the schedule information for the SP.

In the present modification, similar operations and effects to those of the above-described embodiment and the like are also obtained. Note that, in the present modification, since there is only one wireless signal processing unit 220 serving as the A-STA function, the data distribution unit 212 may not be provided in the management unit 210 of the terminal 20, as in the example of FIG. 15 and the like. In this case, the traffic from the LLC processing unit 200 is directly input to the wireless signal processing unit 220.

In addition, the processing according to the embodiment and modification described above can be stored as a program that can be executed by a processor that is a computer. In addition, it is possible to store and distribute a program that executes the above-described processing in a storage medium of an external storage device such as a magnetic disk, an optical disk, or a semiconductor memory. Then, the processor reads the program stored in the storage medium of the external storage device, and the operation is controlled by the read program, whereby processing according to the embodiment or the like can be executed.

Note that the present invention is not limited to the above embodiments, and various modifications can be made in the implementation stage without departing from the gist of the invention. The embodiments may be implemented in appropriate combination, and in this case, a combined effect can be obtained. The above embodiments include various inventions, and various inventions can be extracted by a combination selected from the plurality of disclosed components. For example, in a case where the problems can be solved and the effects can be obtained even if some components are deleted from all the components described in the embodiment, a configuration from which the components are deleted can be extracted as an invention.

Reference Signs List

| | |
|---|---|
| 1 | Communication system |
| 10 | Access point (AP) |
| 20 | Terminal |
| 30 | Network |
| 11, 21 | CPU |
| 12, 22 | ROM |
| 13, 23 | RAM |
| 14, 24 | Wireless communication module |
| 15 | Wired communication module |
| 25 | Display |
| 26 | Storage |
| 100, 200 | LLC processing unit |
| 110, 210 | Management unit |
| 111, 211 | Communication management unit |
| 112, 212 | Data distribution unit |
| 113, 213 | Schedule control unit |
| 120, 130, 140, | Wireless signal processing unit |
| 220, 230, 240 | |
| 161 | Beacon control unit |
| 162 | R-TWT processing unit |
| 163, 263 | Frame processing unit |
| 165, 265 | Transmission/reception unit |
| 171 | Classification unit |
| 172A to 172D | Queue |
| 173A to 173D | Carrier sensing execution unit |
| 175 | Internal collision resolving unit |
| 250 | Application execution unit |
| 261 | Beacon processing unit |

1. An access point comprising:
a plurality of first wireless signal processing circuits; and
first processing circuitry configured to:
establish a plurality of links by using the plurality of first wireless signal processing circuits, and
allocate a service period that gives priority to transmission and reception of low-latency traffic to each of the plurality of links in an allocation pattern in which no break of the service period occurs in switching of the service period among the plurality of links.

2. The access point according to claim 1, wherein the first processing circuitry is configured to allocate the service period to a state in which no collision occurs between the service period and a non-transmittable period in each of the plurality of links.

3. The access point according to claim 1, wherein one or more of the plurality of first wireless signal processing circuits transmit a beacon to provide notification of schedule information indicating the allocation pattern for the service period.

4. The access point according to claim 1, wherein each of the plurality of first wireless signal processing circuits transmits a trigger at each start time of the service period allocated to a corresponding one of the plurality of links.

5. The access point according to claim 4, wherein each of the plurality of first wireless signal processing circuits provides notification of, by transmitting the trigger, information regarding a service period next to the service period started by the trigger.

6. A terminal used with the access point according to claim 1, the terminal comprising:
a second wireless signal processing circuit configured to perform wireless communication through one or more of the plurality of links established between the terminal and the access point to receive schedule information indicating the allocation pattern for the service period; and
second processing circuitry configured to switch a link in which the low-latency traffic is transmitted and received to and from the access point among the plurality of links on a basis of the schedule information received by the second wireless signal processing circuit.

7. The terminal according to claim 6, wherein
a plurality of second wireless signal processing circuits are provided as the second wireless signal processing circuit,
each of the plurality of second wireless signal processing circuits is capable of wireless communication through a corresponding one of the plurality of links, and
the second processing circuitry is configured to switch the link in which the low-latency traffic is transmitted and received among the plurality of links by switching the second wireless signal processing circuit that inputs the low-latency traffic among the plurality of second wireless signal processing circuits.

8. The terminal according to claim 6, wherein
the second wireless signal processing circuit is capable of wireless communication using the plurality of links and capable of transmitting a wireless signal through only one of the plurality of links at same timing, and
the second processing circuitry is configured to switch the link in which the low-latency traffic is transmitted and received among the plurality of links by switching the link in which the second wireless signal processing circuit transmits the wireless signal among the plurality of links.
